(19) United States
(12) Patent Application Publication
(10) Pub. No.: US 2019/0023349 A1
(43) Pub. Date: Jan. 24, 2019

(54) TRANSPORTATION MEANS USING DEVICE FOR CONVERTING RECIPROCATING RECTILINEAR MOTION INTO SINGLE-DIRECTION CIRCULAR MOTION

(71) Applicant: SHENZHEN NANBO AUTOMATION EQUIPMENT CO., LTD., SHENZHEN (CN)

(72) Inventor: Liyuan LUO, SHENZHEN (CN)

(73) Assignee: SHENZHEN NANBO AUTOMATION EQUIPMENT CO., LTD.

(21) Appl. No.: 16/143,320

(22) Filed: Sep. 26, 2018

Related U.S. Application Data
(63) Continuation of application No. PCT/CN2017/077884, filed on Mar. 23, 2017.

(30) Foreign Application Priority Data
Mar. 26, 2016 (CN) 201610179469.5

(51) Int. Cl. B62M 1/30; B62M 1/28; B62M 11/06; B62M 9/02

(52) U.S. Cl. CPC B62M 1/30; B62M 9/02; B62M 11/06; B62M 1/28

(57) ABSTRACT

A transportation means comprises a device for converting a reciprocating rectilinear motion into a single-direction circular motion, a power output mechanism and two co-axially arranged rotating shafts; a circular motion output mechanism of the device is in drive connection with the power output mechanism; each reciprocating rectilinear motion mechanism includes an elongated pedal; a bendable portion is disposed at the end of the elongated pedal distant from the device for converting a reciprocating rectilinear motion into a single-direction circular motion; the bendable portion is in rotational connection with the rotating shaft by means of a torsional spring, so that when the bendable portion rotates around one rotating shaft, the end of the elongated pedal proximate to the device for converting reciprocating rectilinear motion into single-direction circular motion performs small-curvature near-rectilinear motion. The transportation means enables a rider to ride more comfortably with less effort.

### CROSS-REFERENCE TO RELATED APPLICATIONS

This application is a continuation of International Patent Application No. PCT/CN2017/077884 with a filing date of Mar. 23, 2017, designating the United States, now pending, and further claims priority to Chinese Patent Application No. 201610179469.5 with a filing date of Mar. 26, 2016. The content of the aforementioned applications, including any intervening amendments thereto, are incorporated herein by reference.

### TECHNICAL FIELD

The disclosure relates to the technical field of motion conversion, and particularly relates to a transportation means using a device for converting a reciprocating rectilinear motion into a single-direction circular motion.

### BACKGROUND OF THE PRESENT INVENTION

As well known, there are many instances where in daily production it is necessary to convert a rectilinear motion manner into a circular motion which is even in different rotating speeds. At this moment, it is necessary to use a conversion device. However, most of the existing conversion devices are complicated in structure and inconvenient in speed adjustment. For example, when a rider riding on a traditional bicycle with both feet pushing the pedals circularly, the physical power and time are wasted since a moment arm continuously and repeatedly changes from 0 to a maximal value, and a torque also changes from 0 to a maximal value, and therefore physical power and work time of a rider are wasted. The time for shifting the chain between different chain wheels is long.

Thus, the inventor proposes a device for converting a reciprocating rectilinear motion into a single-direction circular motion and a transportation means using the device in Chinese Patent Application No. 201520975174.X. Through the device for converting a reciprocating rectilinear motion into a single-direction circular motion, a reciprocating rectilinear motion can be rapidly converted into a single-direction circular motion, and the device is applied to transportation means (such as bicycle, manual power ship and the like) so as to obtain physical labor-saving transportation means. However, in the Chinese Patent Application, when applying the device for converting a reciprocating rectilinear motion into a single-direction circular motion to the transportation means, the new transportation means is obtained by simply connecting a circular output mechanism of the device for converting a reciprocating rectilinear motion into a single-direction circular motion with the power output mechanism of traditional transportation means, and the user experience is not good enough and the transportation means is not comfortable enough in use.

### SUMMARY OF PRESENT INVENTION

The objective of the disclosure is to provide a transportation means using a device for converting a reciprocating rectilinear motion into a single-direction circular motion, which can make a rider more comfortable and physical labor-saving when riding.

The disclosure is achieved as follows:

A transportation means comprises a device for converting a reciprocating rectilinear motion into a single-direction circular motion, a power output mechanism and two co-axially arranged rotating shafts; the device for converting a reciprocating rectilinear motion into a single-direction circular motion includes a device body as well as two reciprocating rectilinear motion mechanisms, a rectilinear motion conversion mechanism and a circular motion output mechanism that are arranged on the device body; the two reciprocating rectilinear motion mechanisms are respectively in drive connection with the rectilinear motion conversion mechanism; the rectilinear motion conversion mechanism is configured to convert the reciprocating rectilinear motion output from the two reciprocating rectilinear motion mechanisms into a double-direction circular motion; and the rectilinear motion conversion mechanism is further in single-direction synchronous rotational connection with the circular motion output mechanism; the circular motion output mechanism is in drive connection with the power output mechanism; each reciprocating rectilinear motion mechanism includes an elongated pedal; a bendable portion is disposed at the end of the elongated pedal distant from the device for converting a reciprocating rectilinear motion into a single-direction circular motion; and the bendable portion is in rotational connection with the rotating shaft by means of a torsional spring, so that when the bendable portion rotates around the corresponding rotating shaft, an end of the elongated pedal proximate to the device for converting a reciprocating rectilinear motion into a single-direction circular motion performs small-curvature near-rectilinear motion.

As an improvement of the above transportation means, the device for converting a reciprocating rectilinear motion into a single-direction circular motion further includes a rotating speed adjusting mechanism built in the device body; the rectilinear motion conversion mechanism is in single-direction synchronous rotational connection with the rotating speed adjusting mechanism; the rotating speed adjusting mechanism is in drive connection with the circular motion output mechanism; the rotating speed adjusting mechanism comprises N gear sets, wherein, N≥2; each gear set includes a plurality of gears having different diameters; each gear set is respectively in synchronous rotational connection with a rotating shaft corresponding to the gear set; two ends of the rotating shaft corresponding to the gear set are respectively connected with the a bearing of the device body; the N gear sets are meshed in turn; the rotating shaft corresponding to a first gear set is a driving rotating shaft, and the rotating shaft of the Nth gear set is in synchronous rotational connection with the circular motion output mechanism; and a plurality of shifters are arranged in the N gear sets so that adjacent gear sets shift between meshing manners under the driving of the shifters.

As an improvement of the above transportation means, each reciprocating rectilinear motion mechanism further includes a drive chain and a plurality pairs of chain wheels, the drive chain is tightly connected with an end of the elongated pedal proximate to the device for converting the reciprocating rectilinear motion into the single-direction circular motion, and the drive chain is in drive link connection with the plurality pairs of chain wheels and the rectilinear motion conversion mechanism.

As an improvement of the above transportation means, each reciprocating rectilinear motion mechanism further includes a rectilinear sliding rail, a sliding block structure arranged on the rectilinear sliding rail in a sliding manner, a drive chain and a plurality pairs of chain wheels fixedly connected with the sliding block structure: the rectilinear sliding rail is fixedly arranged on the device body; the sliding block structure includes a sliding block body with a bearing groove and a bearing received in and capable of sliding freely in the bearing groove; the bearing is fixedly connected with an end of the elongated pedal proximate to the device for converting a reciprocating rectilinear motion into a single-direction circular motion; and the drive chain is in drive link connection with the plurality pairs of chain wheels and the rectilinear motion conversion mechanism.

As an improvement of the above transportation means, the transportation means is a manual power vehicle or a child toy vehicle or a manual power ship or a manual power umbrella, and the power output mechanism is wheels of the manual power vehicle or wheels of child toy vehicle or a propeller of the manual power ship or a propeller of the manual power umbrella.

The disclosure has the beneficial effects that the disclosure provides a transportation means using a device for converting a reciprocating rectilinear motion into a single-direction circular motion, its reciprocating rectilinear motion mechanism adopts the elongated pedal, so that the tread area of the user is greatly increased, and the user can more comfortably tread. Meanwhile, the bendable portion is disposed at the end of the elongated pedal distant from the device for converting a reciprocating rectilinear motion into a single-direction circular motion, and the bendable portion is in rotational connection with the rotating shaft by means of a torsional spring, so that when the bendable portion rotates around the corresponding rotating shaft, the end of the elongated pedal proximate to the device for converting a reciprocating rectilinear motion into a single-direction circular motion performs small-curvature near-rectilinear motion. The experience of the user can be improved by replacing an original pure rectilinear motion with a small-curvature near-rectilinear motion, and the arrangement of the torsional spring can further save the physical labor of the user. Accordingly, the transportation means using the device for converting a reciprocating rectilinear motion into a single-direction circular motion enables a rider to ride more comfortably with less effort.

### DESCRIPTION OF THE DRAWINGS

In order to make the technical solutions in the disclosure or in the prior art described more clearly, the drawings associated to the description of the embodiments or the prior art will be illustrated concisely hereinafter. Obviously, the drawings described below are only some embodiments according to the disclosure. Numerous drawings therein will be apparent to one of ordinary skill in the art based on the drawings described in the disclosure without creative efforts.

FIG. 1 is a structural diagram of a transportation means using a device for converting a reciprocating rectilinear motion into a single-direction circular motion according to embodiment 1;

FIG. 2 is a structural diagram of the transportation means using the device for converting a reciprocating rectilinear motion into a single-direction circular motion without a device body shown in FIG. 1;

FIG. 3 is a structural diagram of the transportation means using the device for converting a reciprocating rectilinear motion into a single-direction circular motion without a device body according to embodiment 2; and

FIG. 4 is a structural diagram of the transportation means using the device for converting a reciprocating rectilinear motion into a single-direction circular motion with partial exploded components shown FIG. 3.

### DETAILED DESCRIPTION OF PREFERRED EMBODIMENTS

The technical solution in embodiments of the disclosure will be clearly and thoroughly described in combination with drawings in embodiments of the disclosure. Apparently, the described embodiments are only a part of embodiments but not all the embodiments. Based on embodiments described in the disclosure, numerous embodiments therein apparent to those of ordinary skill in the art without creative effort shall fall within the protection scope of the disclosure.

### Embodiment 1

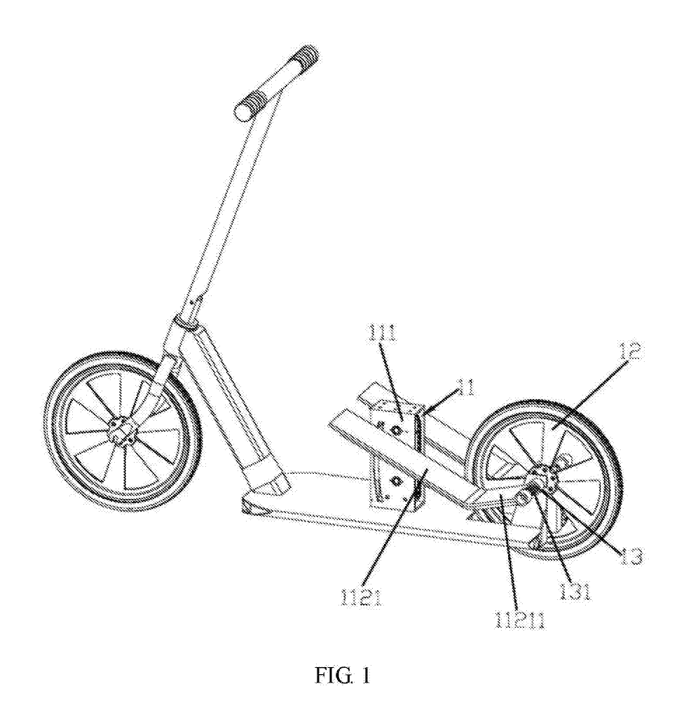

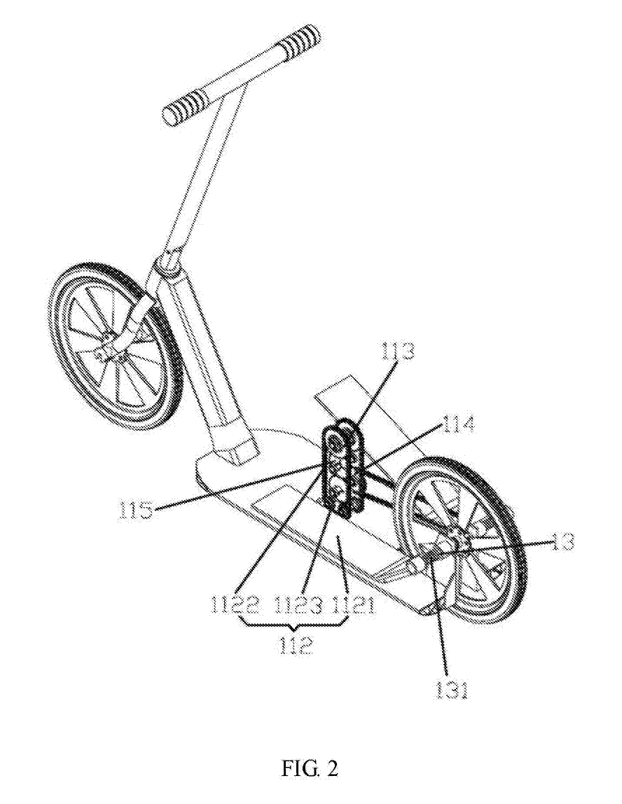

As shown in FIG. 1 and FIG. 2, this embodiment provides a transportation means 1 comprising a device 11 for converting a reciprocating rectilinear motion into a single-direction circular motion, a power output mechanism 12 and two co-axially arranged rotating shafts 13. The device 11 for converting a reciprocating rectilinear motion into a single-direction circular motion includes a device body 111 as well as two reciprocating rectilinear motion mechanisms 112, a rectilinear motion conversion mechanism 113 and a circular motion output mechanism 114 that are arranged on the device body 111. The two reciprocating rectilinear motion mechanisms 112 are respectively in drive connection with the rectilinear motion conversion mechanism 113. The rectilinear motion conversion mechanism 113 is configured to convert the reciprocating rectilinear motion output from the two reciprocating rectilinear motion mechanisms 112 into a double-direction circular motion. The rectilinear motion conversion mechanism 113 is further in single-direction synchronous rotational connection with the circular motion output mechanism 114. The circular motion output mechanism 114 is configured to output a signal-direction circular motion. The circular motion output mechanism 114 is in drive connection with the power output mechanism 12. Each reciprocating rectilinear motion mechanism 112 includes an elongated pedal 1121, a bendable portion 11211 is disposed at the end of the elongated pedal 1121 distant from the device 11 for converting a reciprocating rectilinear motion into a single-direction circular motion. The bendable portion 11211 is in rotational connection with the rotating shaft 13 by means of a torsional spring 131, so that when the bendable portion 11211 rotates around the corresponding rotating shaft 13, the end of the elongated pedal 1121 proximate to the device 11 for converting a reciprocating rectilinear motion into a single-direction circular motion performs small-curvature near-rectilinear motion.

In this embodiment, as shown in FIG. 2, the device 11 for converting a reciprocating rectilinear motion into a single-direction circular motion further includes a rotating speed adjusting mechanism 115 built in the device body 111. The rectilinear motion conversion mechanism 113 is in single-direction synchronous rotational connection with the rotating speed adjusting mechanism 115, and the rotating speed adjusting mechanism 115 is in drive connection with the circular motion output mechanism 114. Particularly, the rotating speed adjusting mechanism 115 comprises N gear sets, wherein, N≥2. Each gear set includes a plurality of gears having different diameters. Each gear set is respectively in synchronous rotational connection with a rotating shaft corresponding to the gear set. Two ends of the rotating shaft corresponding to the gear set are respectively connected with the a bearing of the device body 111. The N gear sets are meshed in turn. The rotating shaft corresponding to a first gear set is a driving rotating shaft, and the rotating shaft of the Nth gear set is in synchronous rotational connection with the circular motion output mechanism 114. A plurality of shifters are arranged in the N gear sets so that adjacent gear sets shift between meshing manners under the driving of the shifters to achieve the objective of shifting an output torque and a rotating speed.

As shown in FIG. 1 and FIG. 2, the transportation means 1 is particularly a manual power vehicle, the power output mechanism 12 is wheels of the manual power vehicle, and two co-axially arranged rotating shafts 13 are oppositely arranged at two sides of the rear wheel of the manual power vehicle. Each reciprocating rectilinear motion mechanism 112 further includes a drive chain 1122 and a plurality pairs of chain wheels 1123. The drive chain 1122 is tightly connected with an end of the elongated pedal 1121 proximate to the device 11 for converting the reciprocating rectilinear motion into the single-direction circular motion, and the drive chain 1122 and the plurality pairs of chain wheels 1123 are in drive link connection with the rectilinear motion conversion mechanism 113.

### Embodiment 2

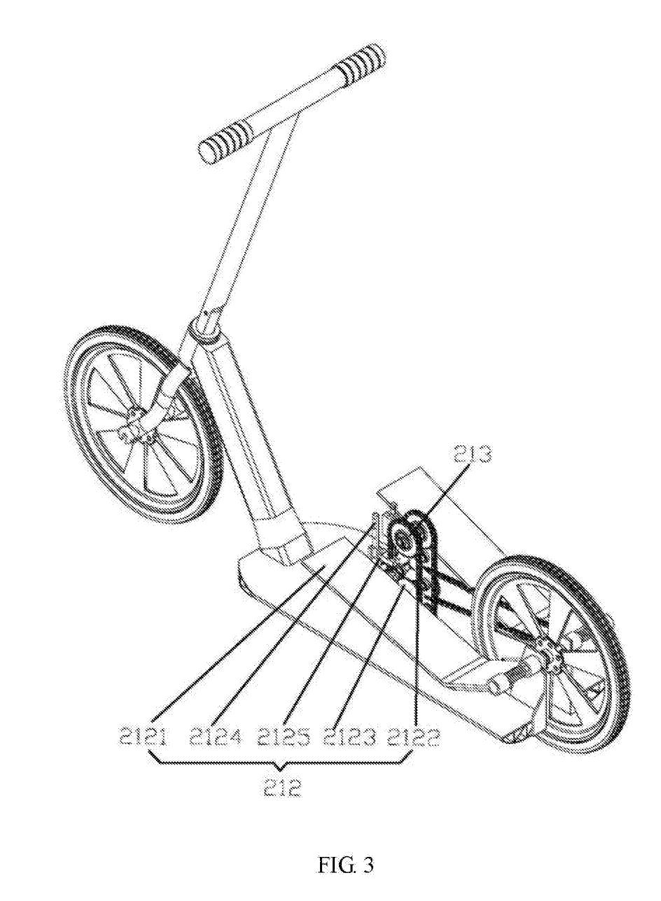

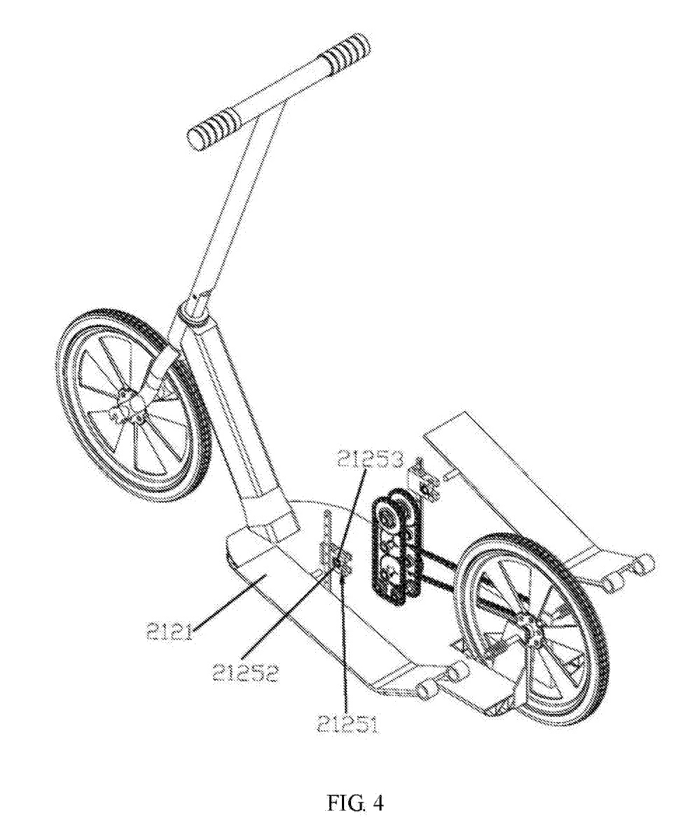

As shown in FIG. 3 and FIG. 4, this embodiment provides a transportation means 2 comprising a device 21 for converting a reciprocating rectilinear motion into a single-direction circular motion. The transportation means 2 differs from the transportation means 1 in embodiment 1 in that a reciprocating rectilinear motion mechanism 112 of the device 21 for converting a reciprocating rectilinear motion into a single-direction circular motion further includes a rectilinear sliding rail 2124, a sliding block structure 2125 arranged on the rectilinear sliding rail 2124 in a sliding manner, a drive chain 2124 and a plurality pairs of chain wheels 2123 fixedly connected with the sliding block structure 2125. The rectilinear sliding rail 2124 is fixedly arranged on the device body (not shown), the sliding block structure 2125 includes a sliding block body 21252 with a bearing groove 21251 and a bearing 21253 placed in and capable of sliding freely in the bearing groove 21251. The bearing 21253 is fixedly connected with an end of the elongated pedal 2121 proximate to the device 21 for converting a reciprocating rectilinear motion into a single-direction circular motion, and the drive chain 2122 is in drive link connection with the plurality pairs of chain wheels 2123 and the rectilinear motion conversion mechanism 213.

In addition, the transportation means using the device for converting a reciprocating rectilinear motion into a single direction circular motion, besides being the manual power vehicle mentioned in embodiment 1 and embodiment 2, can further be a child toy vehicle or a manual power ship or a manual power umbrella or other transportation means using manual power. Correspondingly, the power output mechanism is wheels of the child toy vehicle or a propeller of the manual power ship or a propeller of the manual power umbrella

The disclosure provides a transportation means using a device for converting a reciprocating rectilinear motion into a single-direction circular motion. Its reciprocating rectilinear motion mechanism adopts an elongated pedal, so that the tread area of the user is greatly increased, and the user can more comfortably tread. Meanwhile, since the bendable portion is disposed at the end of the elongated pedal distant from the device for converting a reciprocating rectilinear motion into a single-direction circular motion, the bendable portion is in rotational connection with the rotating shaft by means of a torsional spring, so that when the bendable portion rotates around the rotating shaft, the end of the elongated pedal proximate to the device for converting a reciprocating rectilinear motion into a single-direction circular motion performs small-curvature near-rectilinear motion. The user's experience can be improved by replacing an original pure rectilinear motion with a small-curvature near-rectilinear motion, and the arrangement of the torsional spring can further save the physical labor of the user. Accordingly, the transportation means using the device for converting a reciprocating rectilinear motion into a single-direction circular motion enables a rider to ride more comfortably with less effort.

The above is only preferred embodiments of the disclosure but is not intended to limit the disclosure, and any modification, equivalent substitution, improvements and the like made within the spirit and principle of the disclosure are all included within the protection scope of the disclosure.

I claim:

1. A transportation means comprising a device for converting a reciprocating rectilinear motion into a single-direction circular motion, a power output mechanism and two co-axially arranged rotating shafts; wherein the device for converting a reciprocating rectilinear motion into a single-direction circular motion comprises a device body as well as two reciprocating rectilinear motion mechanisms, a rectilinear motion conversion mechanism and a circular motion output mechanism that are arranged on the device body; the two reciprocating rectilinear motion mechanisms are respectively in drive connection with the rectilinear motion conversion mechanism; the rectilinear motion conversion mechanism is configured to convert the reciprocating rectilinear motion output from the two reciprocating rectilinear motion mechanisms into a double-direction circular motion; the rectilinear motion conversion mechanism is further in single-direction synchronous rotational connection with the circular motion output mechanism, and the circular motion output mechanism is configured to output a single-direction motion; the circular motion output mechanism is in drive connection with the power output mechanism;
each reciprocating rectilinear motion mechanism comprises an elongated pedal; a bendable portion is disposed at an end of the elongated pedal distant from the device for converting a reciprocating rectilinear motion into a single-direction circular motion; and the bendable portion is in rotational connection with the corresponding rotating shaft by means of a torsional spring, so that when the bendable portion rotates around the corresponding rotating shaft, an end of the elongated pedal proximate to the device for converting a reciprocating rectilinear motion into a single-direction circular motion performs small-curvature near-rectilinear motion.

2. The transportation means according to claim 1, wherein, the device for converting a reciprocating rectilinear motion into a single-direction circular motion further comprises a rotating speed adjusting mechanism built in the device body; the rectilinear motion conversion mechanism is in single-direction synchronous rotational connection with the rotating speed adjusting mechanism; the rotating speed adjusting mechanism is in drive connection with the circular motion output mechanism; the rotating speed adjusting mechanism comprises N gear sets, wherein, N≥2; each gear set comprises a plurality of gears having different diameters; each gear set is respectively in synchronous rotational connection with a rotating shaft corresponding to the gear set; two ends of the rotating shaft corresponding to the gear set are respectively connected with the a bearing of the device body; the N gear sets are meshed in turn; the rotating shaft corresponding to a first gear set is a driving rotating shaft, and the rotating shaft corresponding to the Nth gear is in synchronous rotational connection with the circular motion output mechanism; and a plurality of shifters are arranged in the N gear sets so that adjacent gear sets shift between meshing manners under the driving of the shifters.

3. The transportation means according to claim 1, wherein, each reciprocating rectilinear motion mechanism further comprises a drive chain and a plurality pairs of chain wheels, the drive chain is tightly connected with an end of the elongated pedal proximate to the device for converting a reciprocating rectilinear motion into a single-direction circular motion, and the drive chain is in drive link connection with the plurality pairs of chain wheels and the rectilinear motion conversion mechanism.

4. The transportation means according to claim 1, wherein, each reciprocating rectilinear motion mechanism further comprises a rectilinear sliding rail, a sliding block structure arranged on the rectilinear sliding rail in a sliding manner, a drive chain and a plurality pairs of chain wheels fixedly connected with the sliding block structure; the rectilinear sliding rail is fixedly arranged on the device body; the sliding block structure comprises a sliding block body with a bearing groove and a bearing received in and capable of sliding freely in the bearing groove; the bearing is fixedly connected with an end of the elongated pedal proximate to the device for converting a reciprocating rectilinear motion into a single-direction circular motion; and the drive chain is in drive link connection with the plurality pairs of chain wheels and the rectilinear motion conversion mechanism.

5. The transportation means according to claim 1, wherein, the transportation means is a manual power vehicle or a child toy vehicle or a manual power ship or a manual power umbrella, and the power output mechanism is wheels of the manual power vehicle or wheels of the child toy vehicle or a propeller of the manual power ship or a propeller of the manual power umbrella.

6. The transportation means according to claim 2, wherein, the transportation means is a manual power vehicle or a child toy vehicle or a manual power ship or a manual power umbrella, and the power output mechanism is wheels of the manual power vehicle or wheels of the child toy vehicle or a propeller of the manual power ship or a propeller of the manual power umbrella.

7. The transportation means according to claim 3, wherein, the transportation means is a manual power vehicle or a child toy vehicle or a manual power ship or a manual power umbrella, and the power output mechanism is wheels of the manual power vehicle or wheels of the child toy vehicle or a propeller of the manual power ship or a propeller of the manual power umbrella.

8. The transportation means according to claim 4, wherein, the transportation means is a manual power vehicle or a child toy vehicle or a manual power ship or a manual power umbrella, and the power output mechanism is wheels of the manual power vehicle or wheels of the child toy vehicle or a propeller of the manual power ship or a propeller of the manual power umbrella.
